(19) United States
(12) Patent Application Publication
(10) Pub. No.: US 2025/0217903 A1
(43) Pub. Date: Jul. 3, 2025

(54) METHOD FOR MANAGING ENERGY EFFICIENCY IN A FACILITY

(71) Applicant: TotalEnergies OneTech, COURBEVOIE (FR)

(72) Inventors: Sébastien PERRIER, PAU CEDEX (FR); Edgard BERNIER, PAU CEDEX (FR)

(73) Assignee: TotalEnergies OneTech, COURBEVOIE (FR)

(21) Appl. No.: 18/850,622

(22) PCT Filed: Mar. 25, 2022
(86) PCT No.: PCT/IB2022/000153

§ 371 Date: Sep. 25, 2024

(51) Int. Cl. G06Q 50/06; G06Q 10/30

(52) U.S. Cl. CPC G06Q 50/06; G06Q 10/30

(57) ABSTRACT

The invention relates to a method for managing energy efficiency in a given facility, wherein the method comprises the following steps, defining a model for the given facility, the model comprises modeling of different energy systems of the given facility, the given facility delivering a service, each energy system delivering a subservice; diagnosing possible inefficiencies or waste sources via the model; operating the given facility in an actual operating mode, and identifying at least one source of energy or emissions inefficiencies or waste of the actual operating mode based on the diagnosed possible inefficiencies or waste sources.

### CROSS REFERENCE TO RELATED APPLICATIONS

The present application is a U.S. National Phase Application under 35 U.S.C. § 371 of International Patent Application No. PCT/IB2022/000153 filed Mar. 25, 2022. The entire contents of which are hereby incorporated by reference.

### FIELD OF THE INVENTION

The present invention concerns a method for managing energy efficiency in a given facility.

### BACKGROUND

When managing a facility, one may want to reduce the cost and/or ecological impact of said facility.

To do so, one may look into the energy performance of the system.

The norm ISO 50001:2018 entitled “Systèmes de management de l'énergie—Exigences et recommandations pour la mise en œuvre” that was published in August 2018 specifies the requirements for establishing, implementing, maintaining and improving an energy management system.

However, said norm is not adapted to each facility and its teachings are at a very high level of consideration.

Thus, it does not allow customized advice. In particular, it would not consider problems that are specific to one facility in particular.

Further, it does not allow giving advice for improving the management of a facility in realtime.

### SUMMARY

One aim of the invention is thus to offer a method for reducing the cost and/or ecological impact of facilities with personalized advices and enabling real-time feedback.

To that end, the invention relates to a method of the aforementioned type, wherein the method comprises the following steps:
defining a model for the given facility, the model comprises modeling of different energy systems of the given facility, the given facility delivering a service, each energy system delivering a subservice,
diagnosing possible inefficiencies or waste sources via the model,
operating the given facility in an actual operating mode, and
identifying at least one source of energy or emissions inefficiencies or waste of the actual operating mode based on the diagnosed possible inefficiencies or waste sources.

According to specific embodiments of the invention, the method also has one or more of the following features, considered alone or according to any technically possible combination(s):
the method comprises adapting the operation of the facility to eliminate or reduce the at least one source of energy or emissions inefficiencies or waste;
the method comprises displaying recommendations to eliminate or reduce the at least one source of energy or emissions inefficiencies or waste;
the method comprises determining, for each energy system, in the model a reference level depending on the delivered subservice, the reference level being a lowest achievable energy consumption or a lowest achievable emissions depending on the delivered subservice for said given energy system;
for a given delivered service, the reference level is obtained with an optimum operational configuration of the given energy system, said optimum operational configuration being determined based on the model, the at least one source of energy or emissions inefficiencies or waste comprising at least one difference between an actual operational configuration and the optimum operational configuration for the actual delivered subservice;
the method comprises determining an energy efficiency of the given facility, the energy efficiency is equal to the ratio between the energy consumption or emission estimated without the identified at least one source of energy or emissions inefficiencies or waste and an actual energy consumption or emission;
the method comprises determining a lowest possible energy consumption or a lowest possible emissions depending on the delivered service, taking into account at least a possible technological upside of the given facility;
the model is at least partly based on historical data of the given facility;
diagnosing the possible inefficiencies or waste sources comprises determining whether the actual delivered service is not too high in regard to a needed service and/or whether the actual delivered subservice for each energy system is not too high in regard to a needed subservice; and/or
diagnosing the possible inefficiencies or waste sources comprises identifying a degraded energy consumption by one or more equipment in operation of the given facility.

### BRIEF DESCRIPTION OF THE DRAWINGS

Other features and advantages of the invention will appear upon reading the following description, provided solely as an example and done in reference to the appended drawings, in which:

FIG. 1 is a schematic view of an example of a facility,

FIG. 2 is a block diagram illustrating an example of a method according to the invention, and

FIG. 3 is an example of the indicative unit μ of the first energy system of the facility of FIG. 1 relative to the delivered subservice S for different configurations of said first energy system.

### DETAILED DESCRIPTION

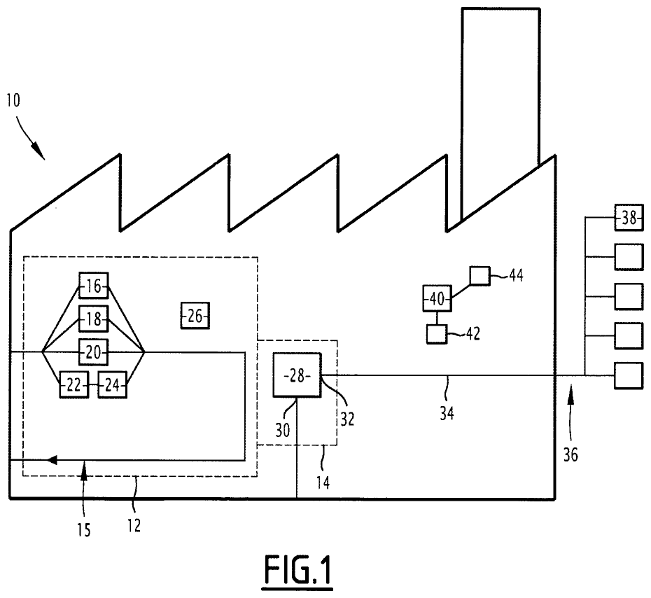

An example of a facility 10 is represented on FIG. 1.

Said example is very simplified, such as to illustrate the purpose of the description. However, the invention is not limited to such a facility and is adaptable to any desired facility.

The facility 10 delivers a service.

The facility 10 is, for example, adapted to pressurize and distribute a gas to different customers.

The facility 10 comprises a plurality of energy systems 12, 14, each energy system 12, 14 delivering a subservice.

A subservice corresponds to a function.

Are part of the same energy system the equipments that contribute to the same subservice and have a certain level of interdependence.

In particular, if different equipments deliver a similar service but are operating in incompatible conditions, or are not in series and do not offer options of interchangeability or ability to share part of the load, the equipments are part of different energy systems, that are independent from another.

Typical subservices are, for example, compression of gas, pumping of liquids, including polyphasic pumping, on-site power generation, heating system or cooling system, disposal or flaring of excess gas or hydrocarbons when technically required.

In the represented embodiment, a first energy system 12 is, for example, a cooling system, and a second energy system 14 is a compression system of the gas, the cooling system being adapted to cool the compression system.

Even if the first energy system provides a subservice in favor of the second energy system, the equipments of the two energy systems do not have the same function, in one case cooling and in the other compressing, such that they are part of two different energy systems with different subservices.

The first energy system 12 for example comprises a cooling circuit 15 of coolant with cooling pumps 16, 18, 20, 22, 24 and at least one cooling equipment 26.

The first energy system 12 could be of any other type, the example being given only for illustrative purposes.

The cooling pumps are here arranged in a combination of in parallel and in series such as to offer options of interchangeability or ability to share part of the load. Alternatively, the cooling pumps could be arranged in series or in parallel.

The cooling pumps 16, 18, 20, 22, 24 have respective specification, for example regarding the pumping capacity with similar input.

Some of the cooling pumps may have similar specifications, such that they are considered similar pumps.

The cooling equipment 26 is adapted to cool the coolant downstream the cooling pumps and upstream the heat exchange with the compression system of the second energy system.

The second energy system 14 comprises, for example, a compressor 28 for compressing gas that is fed to the compressor through an inlet 30.

The compressed gas exits the compressor 28 through an output 32 and into an outlet pipe 34 feeding a circuit 36 supplying different customers 38 with compressed gas.

The facility 10 further comprises sensors (not represented) for measuring the subservice and/or energy consumption or CO2 emission of each energy system or of each equipment.

Alternatively or additionally, at least one of the energy system or equipment has an indicator(s) or operation instructions for calculating the corresponding subservice and/or energy consumption or CO2 emission.

Here, the facility 10 further comprises a calculator 40 and here a memory 42.

The calculator 40 is adapted to received the measured data from the above mentioned sensors and/or the indicators and/or the operation instructions.

The calculator 40 is adapted to model and identify at least one source of energy or emissions inefficiencies or waste based on the model, the actual energy consumption or emission and the actual delivered service.

The calculator 40 is for example implemented in the form of a software, or a software brick, executable by a processor.

In a variant not shown, the calculator 40 is implemented in the form of a programmable logic component, such as an FPGA (Field Programmable Gate Array), or in the form of a dedicated integrated circuit, such as an ASIC (Application Specific Integrated Circuit).

When the calculator is implemented as one or more software programs, i.e., as a computer program, it is further adapted to be recorded on a computer-readable medium, not shown. The computer-readable medium is, for example, a medium capable of storing electronic instructions and of being coupled to a bus of a computer system. For example, the readable medium is an optical disk, a magneto-optical disk, a ROM memory, a RAM memory, any type of non-volatile memory (e.g. EPROM, EEPROM, FLASH, NVRAM), a magnetic card or an optical card. A computer program with software instructions is stored on the readable medium.

Alternatively, the calculator 40 is located remotely, particularly via cloud computing.

The calculator 40 is adapted to store data in the memory 42.

The memory 42 is further adapted to store historical data from other sources than the calculator 40, for example from the sensors.

The facility 10 further comprises a display 44 connected to the calculator 40 for displaying information from the calculator 40.

The display 44 is connected to the calculator 40 by wire or remotely connected.

Alternatively, the calculator 40, the memory 42 and the display 44 are not part of the facility 10, but located outside the facility 10, for example in a different location or via cloud computing.

As mentioned previously, the previously described example of a facility is only given for illustrative reasons.

The facility may be completely different.

In a further example, the facility is a facility for sea water treatment. In particular, the facility is adapted to inject treated sea water at a very high pressure for improved oil recovery.

The facility, for example, comprises a line of treatment that the water follows.

The sea water is, firstly, lifted from the sea or ocean using water lift pumps.

Then, the water is filtered, here using a first coarse filtration and a second fine filtration. The fine filtration, for example, comprises a backwash of the fine filter for clearing the system.

The water is then deaerated in deaeration towers using air ejectors that eject air from the towers and are driven by vacuum pumps.

Advantageously, the sulphate is then removed in a sulphate removal unite that is fed by feed pumps, that are here arranged between the exit of the deaeration towers and the entrance of the Sulphate removal unit.

Lastly, the water is injected in risers and/or injection wells using water injection pumps.

Thus, the facility may be divided in a plurality of energy systems, as defined previously and considered in the rest of the description: a water lifting system, at least one filtration system, a deaeration system including the air ejectors and the vacuum pumps, advantageously a sulphate removal unit including the feed pumps, and the injector system.

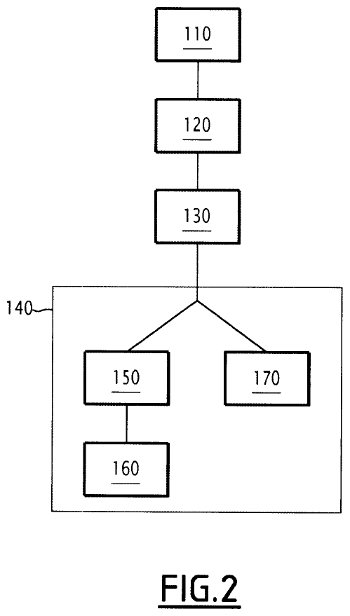

Alternatively, the facility is a facility for processing gas, in particular including compression of the gas, for gas lift and pipeline transportation. A method for managing energy efficiency in a given facility will now be described in view of FIG. 2.

The facility of FIG. 1 will be used to give an example of application of the method.

The method represented in FIG. 2 comprises the following steps:
defining a model for the given facility 110,
diagnosing possible inefficiencies or waste sources via the model 120,
creating a knowledge database for the facility 130, and
identifying inefficiencies and wastes in the actual facility 140.

The steps 110, 120, 130 and 140 are, for example, operated by the calculator.

Defining a model for the given facility 110 corresponds here to defining a model that represents said facility in particular.

In particular, the different energy systems, as defined previously, of the facility are included in the model.

For each energy system, the model comprises a modeling of the equipments composing said energy system and their function, interaction and arrangement within the energy system.

In the example of FIG. 1, the model comprises two energy systems that comprise the equipments previously described.

The nature of each energy system is also here defined.

In particular, the system is called a primary energy system if its consumed energy is an imported energy, bought energy or auto consumed energy, at the level of the facility.

For example, when equipments like pumps, compressors, turbines, power generators or ovens are gas-fired, liquid-fuel fired or solid fuel fired equipments, the associated system is classified as a primary energy system. Systems using electricity from the grid or imported hydrogen are treated as primary energy systems at the level of the facility. A flaring system of an oil and gas facility is a primary energy system.

The system is called a secondary energy system when its consumed energy is a source of energy coming from a primary energy system of the facility, hence produced within the facility.

Secondary energy systems are thus associated to at least one primary energy system.

For example, systems that consume electricity, steam, hydrogen or heat generated on the site are classified as secondary energy systems.

In the embodiment of FIG. 1, the energy systems 12, 14 are, for example, primary energy systems that use energy from the grid.

Further, in the model, one metrics is defined for each energy system, except for a flaring system if applicable.

That enables to normalize the level of provided subservice.

The metrics is generally the delivered power.

The metrics are, for example, for a power generation system the produced electricity power in watts or equivalent, for a liquid pumping system or polyphasic the delivered hydraulic power (being a multiple of the pumped rate by the elevation of pressure) in watts or equivalent, and for a gas compression system the compression power in watts or equivalent. For a constant elevation pumping or compression system, the metrics is, for example, the delivered rate. For heating or cooling systems, the metrics is, for example, based on the energy transferred.

For each energy system, the nature of their inlet energy is defined.

In some cases, equipments have dual energy sources that are also modeled. For example, a pump with a gas or power inlet energy can have a back-up diesel generator.

For each equipment of each energy system, a relationship between the energy consumed by said equipment and the associated direct or indirect CO2 emissions is established.

In the case of secondary energy equipment, the relationship is done with the intensity of the associated direct or indirect CO2 emissions of the associated primary energy system.

The model is then used for diagnosing possible inefficiencies or waste sources 120.

Historical data are, for example, used during step 120.

For each energy system, all the possible operational configurations for operating said energy system are defined.

To do so, previously used operational configurations are included, but not only.

Theoretical configurations adapted to operate the energy system in the facility are, for example, also here included.

In the example of FIG. 1, each pump 16, 18, 20, 22, 24 may be operated individually at different rates, but also any combination of said pumps are considered.

For each operational configuration, is established the level of delivered subservice in regard to an indicative unit.

This is done using historic data and/or extrapolation from historic data and/or simulations of the model.

The indicative unit is the energy consumption of the energy system or the CO2 emissions emitted by the energy system at said operational configuration.

When a mix of type of inlet energy is used, the indicative unit is preferably the CO2 emissions emitted by the energy system at said operational configuration

Some distinct operational configurations can have similar energy performance, i.e. consume a similar quantity of energy or emit similar CO2 emissions for a similar subservice. These configurations form what is called a cluster of configurations.

For example, in a fleet of n similar equipments with similar performances, any combination of m equipments picked within the n equipments is likely to have a similar energy performance, and thus be part of a same cluster.

Similarly, combinations of n similar high capacity machines and o similar lower capacity machines are also expected to group in a same cluster.

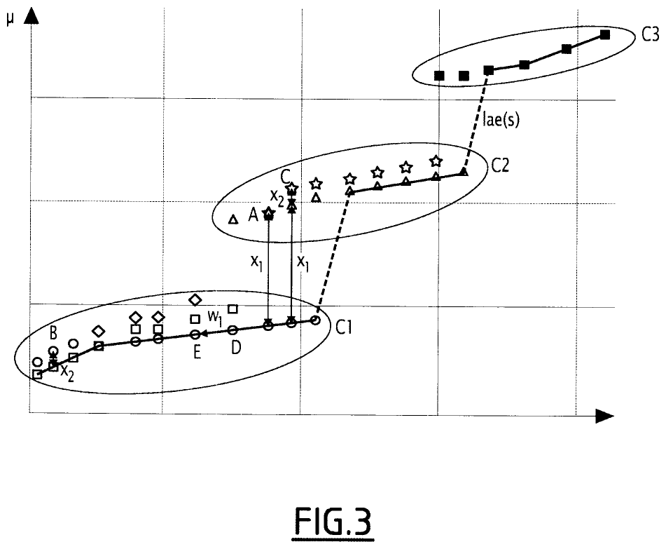

In FIG. 3, is, for example, represented the indicative unit μ of the first energy system of the facility of FIG. 1 relative to the delivered subservice S, when different pumps are used at different rates in order to produce said delivered subservice.

The data corresponding to FIG. 3 are imagined for the purpose of explaining the invention.

The first cluster C1 corresponds here to the case when only one of the pumps 16, 18, 20, 22, 24 is used.

Each shape corresponds to a particular pump, the pump being operated at different rates to obtain different value of subservices.

The second cluster C2 corresponds here to the case when only two of the pumps 16, 18, 20, 22, 24 are used.

Each shape corresponds to a particular combination of two given pumps, the pumps being operated at different rates to obtain different value of subservices.

The third cluster C3 corresponds here to the case when only three of the pumps 16, 18, 20, 22, 24 are used.

Only one combination of three given pumps is represented in FIG. 3.

Other combinations of the pumps of the facility would be considered, but only some are represented in FIG. 3, for the clarity of said figure.

In one embodiment, the method, in particular step 120, comprises determining, for each energy system, in the model, a reference level lae depending on the delivered subservice S. The reference level lae is a lowest achievable energy consumption or a lowest achievable emission depending on the delivered subservice S for said given energy system.

The reference level lae is thus the lowest achievable indicative unit μ for a given value of the delivered subservice S.

The reference level is obtained with an optimum operational configuration of the given energy system.

Said optimum operational configuration is thus determined for different values of delivered subservice S based on the model.

In FIG. 3, the reference level is represented as a solid line.

Possible inefficiencies diagnosed at step 120 comprise, for example, operating an energy system of the facility differently from the optimum operational configuration for a wanted delivered subservice.

For example, if the first energy system is operated according to configuration A as represented in FIG. 3, it would be more efficient to use only one equipment instead of the two equipments of configuration A, in particular the equipment represented with a circle.

If the first energy system is operated according to configuration B as represented in FIG. 3, it would be more efficient to use the equipment represented with the square, instead of the equipment represented with a circle.

If the first energy system is operated according to configuration C as represented in FIG. 3, it would be more efficient to use the combination of equipments represented with the triangle with the corresponding configuration, but even more efficient to use only the equipment represented with a circle.

Thus, possible inefficiencies diagnosed at step 120 comprise operating the energy system with an inadapted number of equipments, named x1, but also with an equipment or a combination of equipments that are not optimal, named x2.

In a particular embodiment, the method, in particular step 120, further comprises diagnosing possible time-dependent inefficiencies at the equipment level for at least one equipment, named x3.

This comprises identifying a degraded energy consumption by one or more equipment in operation of the given facility.

This is done if sufficient historic data exist at equipment level for said equipment, in particular regarding the energy consumption or CO2 emissions of the equipment over time, called observed inlet over time i(t), and the output relative to the subservice provided by the equipment over time, called observed output over time o(t).

Said historic data may be measured data, data obtained through virtual metering or based on estimation techniques.

Here, said historic data are measured data.

A regression function R(i) between the function of observed inlet over time and the output over time is calculated.

The regression function is, for example, linear, polynomial or linear per segment, or eventually any other curve that fits within the acquired data.

A residue function σ depending on time is defined as the difference between the observed inlet i at said time and the regression function R for the output at said time: σ(t)=i(t)−R(o(t)).

The evolution of the residue function is analyzed to detect a temporal trend and create an indicator of time-related deviation, while accepting the presence of a reasonable level of noise.

If no temporal trend is apparent and the amplitude of the noise is limited to a criteria, for example to one or two standard deviations of the function i(t), then the possible time-dependent inefficiency related to said equipment is calculated as x3(t)=i(t)−R(o(t)).

If no temporal trend is apparent and the amplitude of the noise is above the previous criteria, then the possible time-dependent inefficiency related to said equipment is calculated as x3(t)=i(t)−R(o(t))+ε₁ with ε₁ a number defined such that the proportion of negative values of the function i(t)−R(o(t))+ε₁ is equal to a percentile p, for example percentile 10.

If a temporal trend is apparent, then the possible time-dependent inefficiency related to said equipment is calculated x3(t)=i(t)−R(o(t))+ε₂ with ε₂ a number defined such that the time-dependent trend is neutralized before the trend initiated.

If after having corrected a temporal trend, a noise above the criteria remains, then a further correction ε₁ with ε₁ a number defined such that the proportion of negative values of the function i(t)−R(o(t))+ε₂+ε₁ is equal to a percentile p, for example percentile 10. Thus, the possible time-dependent inefficiency related to said equipment is, for example, calculated as x3(t)=i(t)−R(o(t))+ε₁+ε₂.

Possible time-dependent inefficiency may be calculated otherwise or taking into account other rules.

In a system comprising a plurality of equipments, the possible time-dependent inefficiencies at the level of the system is equal to the sum of the possible time-dependent inefficiencies of the active equipment(s) of said system.

If insufficiently reliable historic data exist at equipment level, diagnosing possible time-dependent inefficiencies for said equipment is not done.

In a particular embodiment, alternatively or additionally, the method, in particular step 120, comprises diagnosing from the model a possible waste source linked to a delivered subservice in excess relative to the needs, named w1.

In other words, waste w1 relates to whether the actual delivered service is not too high in regard to a needed service and/or whether the actual delivered subservice for each energy system is not too high in regard to a needed subservice.

For example, as depicted on FIG. 3, it is diagnosed that the needed subservice is actually point E, and not the actual delivered subservice D.

This may, for example, be delivered pressure in excess of the real need in case of compression or pumping, reductions of pressure without technical justifications other than losses or undesired restrictions to the flow, or a component of the processed rates that is not used or valorized downstream of the corresponding energy system.

For example, a pressure loss may be identified downstream of the pumps of the first energy system, in particular linked to a conduit, such that a waste of energy could arise if the pumps produce a pressure to overcome such a pressure loss.

In a particular embodiment, one may further identify a possible waste source linked to different needs downstream of the corresponding system or the facility, named w2.

In particular, waste w2 accounts for the waste linked to the most demanding user of the service or subservice.

In the embodiment represented in FIG. 1, a source of waste w2 could be if a first consumer 38 needed a gas pressure above a given pressure P1, while a second consumer needed a gas pressure above a given pressure P2 and the other consumers needed a gas pressure above a given pressure P3, P1 being superior to P2 being superior to P3.

The compressor 28 would need to account for the most demanding consumer, i.e here the first consumer such that the gas pressure would be P1 for all the customers 38.

The total waste w2 is equal to the sum for each user or consumer of the energy needed to go from the need of said user or consumer to the need of the most demanding user or consumer.

One may further calculate the portion of waste w2 attached to the most demanding user or consumer. Said portion is the total energy needed for all the users or consumers, apart from the most demanding user, to go from the need of the second most demanding user or consumer to the need of the most demanding user or consumer.

Indeed, without the most demanding user or consumer, the service or subservice would have to be provided at the level for the second most demanding customer or user.

A knowledge database for the facility 130 is created.

Said knowledge database links the possible sources of energy or emissions inefficiency or waste to a course of action to remedy said inefficiency or waste.

For inefficiencies x3, the associated recommendation is, for example, to observe a drift in performance, and to point out at its causes, when this can be modelled or understood.

For inefficiencies x1 and x2, the associated recommendation is to compare the actual operational configuration to the optimum operational configuration, in order to change the configuration accordingly.

Regarding waste w1, the associated recommendation is to lower the effectively needed service or subservice.

There is no direct recommendation regarding waste w2, as this would impact the global throughput to affect the most demanding user. Further, waste w2 does not usually depend on the given facility but on the most demanding user or consumer.

However, the waste w2 is, for example, used to give a cost linked to this higher demand, and consider challenging it, in particular regarding the most demanding user or consumer.

Waste w2 is dealt after waste w1.

Step 140 comprises the following substeps:
operating 150 the given facility in an actual operating mode, and
identifying 160 at least one source of energy or emissions inefficiencies or waste.

The actual operating mode comprises, for each energy system, the delivered subservice, the combination of active equipments and their respective functioning regimes or rates.

One, in particular the calculator, compares the actual operating mode in regard to the diagnosed possible inefficiencies or waste sources.

At least one source of energy or emissions inefficiencies or waste is identified from the different previously diagnosed possible inefficiencies or waste sources.

The at least one source of energy or emissions inefficiencies or waste, for example comprises at least one difference between an actual operational configuration and the optimum operational configuration for the actual delivered subservice, or time-dependent inefficiencies x3, or waste w1.

The method further comprises adapting the operation of the facility to eliminate or reduce the at least one source of energy or emissions inefficiencies or waste.

How to eliminate or reduce said at least one source of energy or emissions inefficiencies or waste is determined by the knowledge database.

In particular, if it has been identified that, for an energy system, the equipments are not operated in the optimum operational configuration to obtain the needed subservice such that this is a source of efficiencies, then the configuration of equipments for said energy system is changed to said optimum operational configuration.

Additionally or alternatively, the method comprises displaying, here on display 44, recommendations to eliminate or reduce the at least one source of energy or emissions inefficiencies or waste.

Said recommendations are based on the knowledge database.

Thus, said at least one source of energy or emissions inefficiencies or waste may then be eliminated or reduced.

The calculator further calculates the lowest achievable energy consumption or emissions from the actual operating mode.

The lowest achievable energy consumption or emissions from the actual operating mode is the energy consumption or emission estimated without the identified at least one source of energy or emissions inefficiencies or waste, in particular without the inefficiencies x1, x2 and eventually x3 and without waste w1.

At a facility scale, each of the reference level lae, inefficiencies x1, inefficiencies x2, inefficiencies x3, waste w1, and waste w2 is equal to the sum of all the reference levels lae, or inefficiencies x1, or inefficiencies x2, or inefficiencies x3, or wastes w1, or wastes w2 respectively, coming from each energy system.

The method further comprises determining an energy efficiency of the given facility, the energy efficiency is equal to the ratio between the lowest achievable energy consumption or emissions from the actual operating mode and an actual energy consumption or emission.

The model allows for a real time diagnosis and advice.

Here, a real-time system corresponds to a system subject to a real-time constraint. Such constraint is linked to the operating conditions of the facility.

The operating conditions of the facility are discretized.

For example, the model comprises running the calculations every fifteen minutes, such that the management of the facility is adapted within fifteen minutes.

In parallel, the method, in particular step 140, may further comprise determining a lowest possible energy consumption or a lowest possible emission depending on the delivered service 170.

The lowest possible emissions or energy consumption takes into account the previously identified inefficiencies x1, x2 and eventually x3 and waste w1, but also a possible technological upside of the given facility and/or reducing waste not directly depending on the given facility.

The waste not directly depending on the given facility, for example, comprises waste w2 or the impact of external specifications or constraints.

The technological upside corresponds to the excess in energy consumption or emissions associated to using an actual equipment instead of a more efficient equipment, called reference equipment.

The reference equipment is, for example, available on the market or in development.

The reference equipment may also be a theorical equipment used as a benchmark for assessing ideal performances.

Thus, the method is then adapted to give recommendations for future developments or evolutions of the facility or for a benchmark between different facilities.

The method of the invention allows identifying analytically sources of energy or emissions inefficiencies or waste in an actual operating mode of a facility and giving direct advice to improve the energy efficiency of the facility, in real time, but also for the future, and advantageously to keep analytical record of inefficiencies.

The method is adapted to the specific facility, thanks to the model, such that the managing of the energy efficiency takes into account the specificities of said given facility.

1. A method for managing energy efficiency in a given facility delivering a service, the facility comprising different energy systems delivering a subservice, each energy system comprising different equipments contributing to the same subservice, wherein the method comprises the following steps:
defining a model for the given facility, the model comprises modeling of the different energy systems, including modeling the equipments for each energy system
diagnosing possible inefficiencies and/or waste sources via the model, the diagnosing of inefficiencies comprising:
diagnosing possible time-dependent inefficiencies at the equipment level for at least one equipment, and/or
determining if the energy system operates with an equipment or a combination of equipment that are not optimal, and/or
determining if the energy system operates with an inadapted number of equipments, and the diagnosing of waste sources comprising diagnosing from the model a possible waste source linked to a delivered subservice in excess relative to the needs,
operating the given facility in an actual operating mode, and
identifying at least one source of energy or emissions inefficiencies or waste of the actual operating mode based on the diagnosed possible inefficiencies or waste sources.

2. The method according to claim 1, wherein the method comprises adapting the operation of the facility to eliminate or reduce the at least one source of energy or emissions inefficiencies or waste.

3. The method according to claim 1, wherein the method comprises displaying recommendations to eliminate or reduce the at least one source of energy or emissions inefficiencies or waste.

4. The method according to claim 1, wherein the method comprises determining, for each energy system, in the model a reference level depending on the delivered subservice, the reference level being a lowest achievable energy consumption or a lowest achievable emissions depending on the delivered subservice for said given energy system.

5. The method according to claim 4, wherein, for a given delivered service, the reference level is obtained with an optimum operational configuration of the given energy system, said optimum operational configuration being determined based on the model, the at least one source of energy or emissions inefficiencies or waste comprising at least one difference between an actual operational configuration and the optimum operational configuration for the actual delivered subservice.

6. The method according to claim 1, wherein the method comprises determining an energy efficiency of the given facility, the energy efficiency is equal to the ratio between the energy consumption or emission estimated without the identified at least one source of energy or emissions inefficiencies or waste and an actual energy consumption or emission.

7. The method according to claim 4, wherein the method comprises determining a lowest possible energy consumption or a lowest possible emissions depending on the delivered service, taking into account at least a possible technological upside of the given facility.

8. The method according to claim 1, wherein the model is at least partly based on historical data of the given facility.

9. The method according to claim 1, wherein diagnosing possible inefficiencies comprises diagnosing the possible time-dependent inefficiencies, and determining if the energy system operates with an equipment or a combination of equipment that are not optimal, and determining if the energy system operates with an inadapted number of equipments.

10. The method according to claim 1, wherein diagnosing possible wastes further comprises identifying a possible waste source linked to different needs downstream of the corresponding system or the facility.
